(19) United States
(12) Patent Application Publication
(10) Pub. No.: US 2024/0086188 A1
(43) Pub. Date: Mar. 14, 2024

(54) AUTOMATIC NAVIGATION BETWEEN REFERENCE ARCHITECTURE AND CODE REPOSITORY

(71) Applicant: INTERNATIONAL BUSINESS MACHINES CORPORATION, Armonk, NY (US)

(72) Inventors: Saraswathi Sailaja PERUMALLA, Visakhapatnam (IN); Sarbajit K. RAKSHIT, Kolkata (IN); Omkar Nath BAG, Balangir (IN)

(21) Appl. No.: 17/930,871

(22) Filed: Sep. 9, 2022

(51) Int. Cl. G06F 8/76; G06F 8/77

(52) U.S. Cl. CPC G06F 8/76; G06F 8/77

(57) ABSTRACT

Information based on an action performed relating to a portion of code of an application stored using a code repository is obtained. The portion of code is dynamically aligned with at least one component of a reference architecture relating to the application. A correlation exists between the portion of code of the code repository and the reference architecture. Based on the information, navigating is automatically performed to a specified location. The specified location is a selected area in the code repository or a selected area in the reference architecture.

### BACKGROUND

One or more aspects relate, in general, to processing within a computing environment, and in particular, to facilitating such processing.

Processing within a computing environment is facilitated by use of reference architectures that provide information relating to projects, including software applications of the projects, and by use of code repositories that store application code and/or information relating to applications.

A reference architecture includes, for example, a set of one or more documents that provide recommended structures and an integration of information technology (IT) products and services to form a solution. The document(s) may include text, diagrams, templates and/or other information presented in various forms. A reference architecture embodies accepted industry best practices and suggests optimal delivery techniques for specific technologies. It provides solutions and/or facilitates in developing projects, such as software projects, to provide functionality within the computing environment, and/or other projects for various industries.

A code repository is, for example, a file archive and/or a web hosting facility for storing source code of applications, documentation, web pages and/or other works. It is used to maintain revision information, version history and/or version control. It may also provide error information, release management, mailing lists and/or project documentation.

Use of reference architectures and code repositories, as they relate to application code, is to be facilitated.

### SUMMARY

Shortcomings of the prior art are overcome, and additional advantages are provided through the provision of a computer-implemented method of facilitating processing within a computing environment. The computer-implemented method includes obtaining information based on an action performed relating to a portion of code of an application stored using a code repository. The portion of code is dynamically aligned with at least one component of a reference architecture relating to the application. A correlation exists between the portion of code of the code repository and the reference architecture. Based on the information obtained, automatically navigate to a specified location. The specified location is one of a selected area in the code repository and a selected area in the reference architecture.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1A depicts one example of a computing environment to perform, include and/or use one or more aspects of the present invention;

FIG. 1B depicts one example of processing engines executable by a processor set of FIG. 1A, in accordance with one or more aspects of the present invention;

FIG. 2 depicts one example of a reference architecture used in accordance with one or more aspects of the present invention;

FIG. 3 depicts one example of a code repository used in accordance with one or more aspects of the present invention;

FIG. 4 depicts one example of an overview of a process to automatically navigate between a reference architecture and a code repository (e.g., version control tool), in accordance with one or more aspects of the present invention;

FIGS. 5A-5B depict one example of further details of a process to automatically navigate between a reference architecture and a code repository (e.g., version control tool), in accordance with one or more aspects of the present invention; and

FIG. 6 depicts one example of a machine learning training system used in accordance with one or more aspects of the present invention.

### DETAILED DESCRIPTION

In one or more aspects, a capability is provided to facilitate processing within a computing environment. Processing is facilitated by, for example, facilitating and/or improving navigation between a reference architecture and a code repository; facilitating and/or improving application code development, deployment and/or maintenance; facilitating and/or improving analysis of status logs of an application and/or the automatic update of a reference architecture corresponding to application code. By facilitating one or more of these aspects, processing within the computing environment is improved and unnecessary use of system resources is reduced. In one or more aspects, the use of a reference architecture provides a standard solution for a particular project/industry; improves interoperability of software and/or hardware within a computing environment; reduces development costs; and/or facilitates training.

In one or more aspects, application code and log navigation are performed from a reference architecture. In one example, automatic navigation between a reference architecture and a code repository, such as a version control tool, is provided. A portion of code, such as a code branch, of the application, which is located or represented within a code repository is dynamically aligned with the reference architecture. A user (e.g., developer, architect, etc.) can perform interaction with the reference architecture to select a particular code branch. Tags of the code in the code repository are analyzed, as well as code functionalities. Further, image and text analyses of the reference architecture are performed. The analyses of the code repository and the reference architecture are used to align the code as per the reference architecture and provide a mapping between the reference architecture and the code repository.

One or more aspects of the present invention are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing a process (or multiple processes) that, e.g., automatically navigates between a reference architecture and a code repository and/or performs one or more other aspects of the present invention. Aspects of the present invention are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

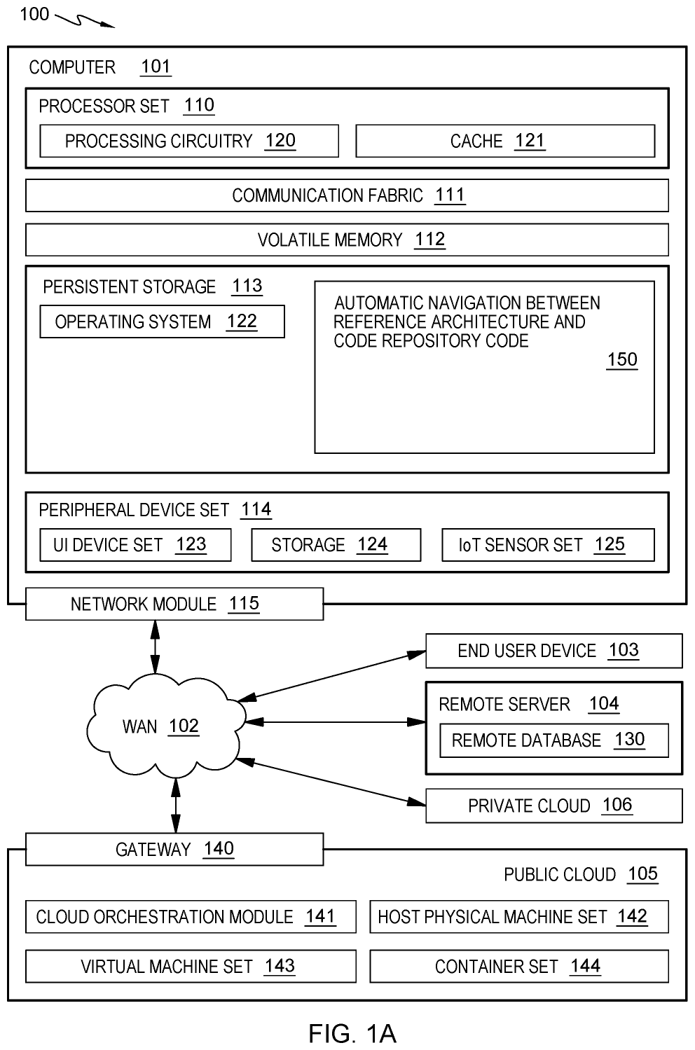

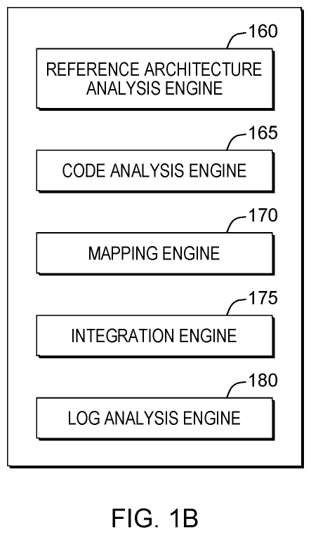

One example of a computing environment to perform, incorporate and/or use one or more aspects of the present invention is described with reference to FIG. 1A. In one example, a computing environment 100 contains an example of an environment for the execution of at least some of the computer code involved in performing the inventive methods, such as automatic navigation between a reference architecture and a code repository code 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1A. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In one or more aspects, to automatically navigate between a reference architecture and a code repository, various processing engines executed by one or more computers, such as computer(s) 101, are used. For instance, the processing engines are executed by one or more processors of one or more processor sets (e.g., processor set(s) 110) and/or using processing circuitry (e.g., processing circuitry 120) of the one or more processor sets. Example processing engines used to perform one or more aspects of the present invention are described with reference to FIG. 1B, and include, for instance: a reference architecture analysis engine 160 to perform analysis of the reference architecture; a code analysis engine 165 to perform analysis of code of the code repository; a mapping engine 170 to map code components of the code repository with components of the reference architecture; an integration engine 175 to correlate the reference architecture and the code repository; and a log analysis engine 180 to perform analysis of logs generated by applications of the code repository. Although example engines are provided, additional, fewer and/or other processing engines may be used.

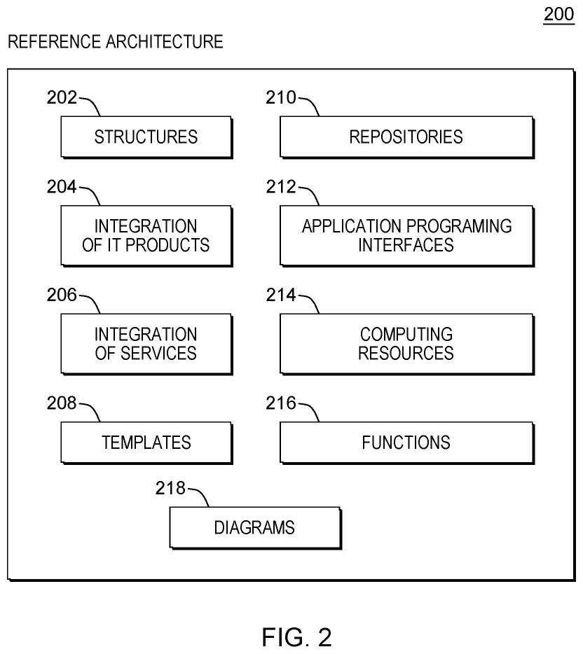

One example of a reference architecture used in accordance with one or more aspects of the present invention is described with reference to FIG. 2. As an example, a reference architecture 200 includes, for instance, one or more documents that describe components (e.g., functions, objects, modules, blocks, implementation steps, workflow, textual information, best practices, etc.) of the reference architecture. The detail described or depicted in the document(s) depends on the level of abstraction of the reference architecture. For example, for a communications network, a high level of abstraction may include an indication of equipment for the communications network, while a lower more granular level may include functions or modules within a computer program used within the communications network. Many possibilities exist.

In one example, reference architecture 200 may include one or more of the following documents, as examples: one or more structures 202, an integration of information technology (IT) products 204, an integration of services 206, one or more templates 208, one or more repositories 210, one or more application programming interfaces 212, one or more computing resources 214, one or more functions 216 and/or one or more diagrams 218. A reference architecture may include additional, fewer and/or other documents than those mentioned herein. The documents included in a particular reference architecture are those used, in one example, to facilitate the provision of a solution for an architecture for a selected project in, e.g., a selected industry.

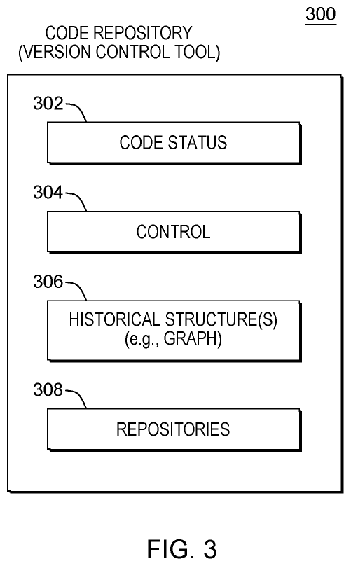

Further, one example of a code repository used in accordance with one or more aspects of the present invention is described with reference to FIG. 3. In one example, a code repository 300 is a version control tool, which provides, for instance, code status 302 (e.g., versions of code, including versions of particular portions of code (also referred to as code branches); control 304 which manages changes to code; one or more historical structures 306 (e.g., graph(s)) to provide historical information regarding the code and/or changes to the code; and one or more repositories 308 to store the code itself, an indication of the code and where it might be stored if other than in the repository, and/or information relating to the code. Although one example of a code repository is described, other examples are possible and may include additional, fewer and/or other information, functions, etc. One example of a version control tool is the GitHub® tool offered by GitHub, Inc., San Francisco, CA. GitHub is a registered trademark of GitHub, Inc., San Francisco, CA. Other version control tools or code repositories may be used.

In one or more aspects, a mapping between code within a code repository (e.g., code repository 300, such as a version control tool) and a reference architecture (e.g., reference architecture 200) is performed in which one or more portions of code (e.g., code branch(es)) from the code repository are dynamically aligned with one or more components of the reference architecture. The mapping enables, for instance, a selection of a component in the reference architecture to automatically provide an indication of corresponding code (e.g., code branch) in the code repository; and the selection of a portion of code (e.g., a code branch) in the code repository automatically provides an indication of one or more corresponding components in the reference architecture.

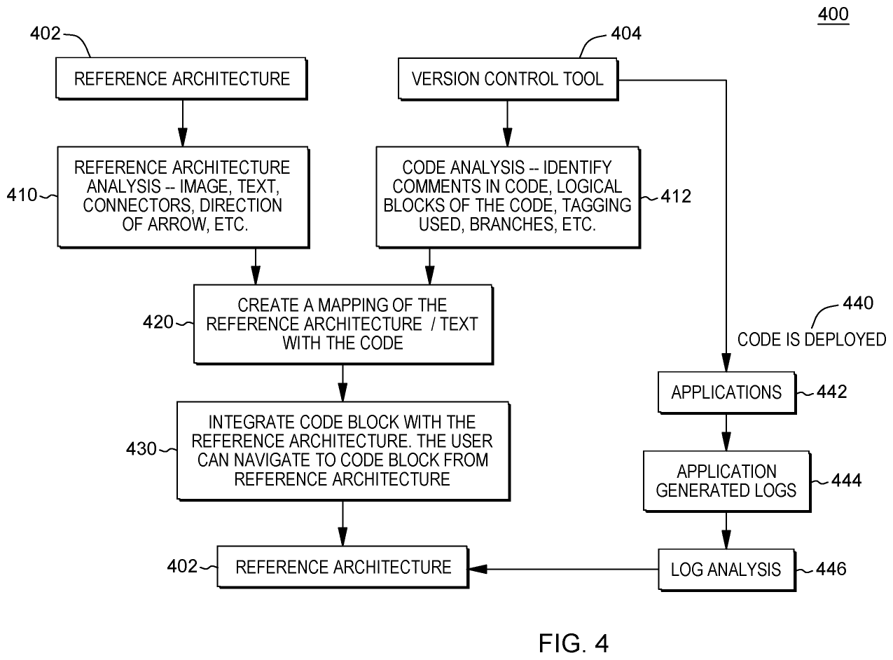

One example of an overview of a process to perform such mapping, and to automatically navigate between a reference architecture and a code repository is described with reference to FIG. 4. In this example, the code repository is a version control tool, and therefore, reference is made to a version control tool. However, this is only one example. Other example code repositories may be used.

Referring to FIG. 4, in one example, a process 400 executing on a processor set (e.g., processor set 110) analyzes 410 a reference architecture 402 (an example of which is described with reference to FIG. 2) to identify selected information. As an example, process 400 uses a reference architecture analysis engine, such as reference architecture analysis engine 160, to identify images, text, connectors, directions of arrows and/or other information of the reference architecture that may aid in navigating to code relating to the reference architecture that is located in a code repository, such as a version control tool 404 (e.g., an example of which is described with reference to FIG. 3). For instance, the reference architecture analysis engine performs image and textual analysis of the architectural documents to identify the direction of any arrows (e.g., where they start, where they end), identify the type(s) of arrows, such as dotted lines, solid lines, other types of lines, different color codes, etc., recognize different image objects in the documents, determine textual information associated with different image objects of the documents, identify legends mentioned in the documents, etc. Based on, for instance, the arrow directions, analysis is performed to determine how the data is moving, etc. Further, based on the analysis of the documents, identification is made of how different image objects are correlated, their dependencies, and/or different conditions, and accordingly, a determination is made as to the architecture of the solution. Based on the information, contextual meaning/functionalities of each and every block/image objects (or selected blocks/image objects), their relationships, etc. are created.

Process 400 further analyzes 412 code within version control tool 404. For instance, process 400 uses a code analysis engine (e.g., code analysis engine 165) to identify comments in the code, one or more logical blocks of the code, tagging used within the code, branches within the code, etc. As an example, the code analysis engine extracts comments in the code, performs contextual analysis of the comments in the code, and uses any standard code analysis of the code (now known or later developed) to identify different functionalities of the code.

Process 400 creates 420 a mapping of the reference architecture and text within the code. For instance, process 400 uses a mapping engine, such as mapping engine 170, to map certain components of reference architecture 402 with particular code within version control tool 404. As an example, the mapping engine correlates the contextual meaning and functionalities identified from the architectural document and the code from the code repository.

Process 400 integrates 430 one or more portions of code (e.g., code blocks, code branches, etc.) of version control tool 404 with one or more components of reference architecture 402. As an example, the process uses an integration engine, such as integration engine 175, to integrate the portion(s) of code (e.g., code branch(es), code block(s)) and reference architecture component(s) enabling a developer or other user to navigate to the portion of code of the version control tool from the reference architecture and from a component of the reference architecture to a portion of code of the version control tool. The integration includes identifying a correlation (e.g., represented using, e.g., a pointer, a link, a name, an identification pair, etc.) via, e.g., the mapping, between a component (e.g., object, module, or other component) in the reference architecture that is associated with a particular portion of code (e.g., code block, code branch, etc.) of the version control tool.

Additionally, in one example, code of version control tool 404 is deployed 440 to execute one or more application 442. At least one application of the one or more applications 442 generates 444 one or more logs. The one or more logs are analyzed 446 using, for instance, a log analysis engine (e.g., log analysis engine 180) to identify, for instance, one or more portions of code that generated a log, one or more changes to be made to the code, etc. Information relating to the log may be shown on the reference architecture and/or applied to the code.

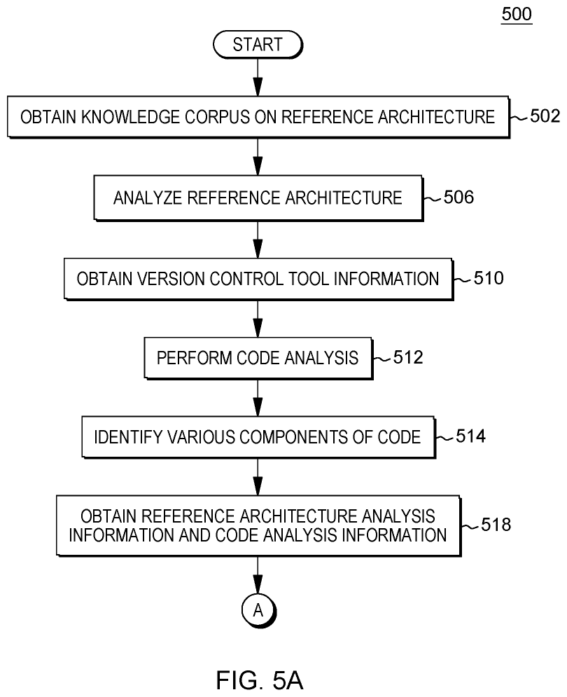

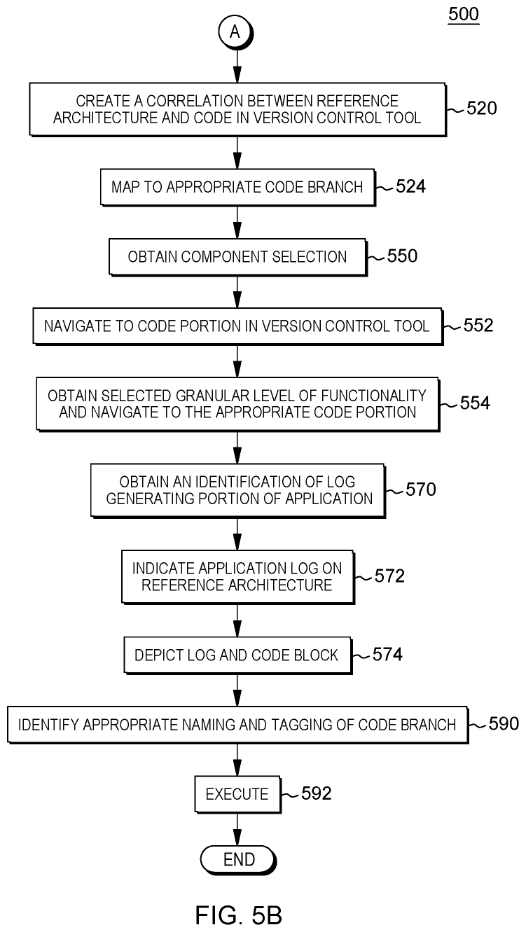

Further details regarding a process to automatically navigate between a reference architecture and a code repository are described with reference to FIGS. 5A-5B. Referring initially to FIG. 5A, in one example, a process 500 executing on a processor set (e.g., processor set 110) obtains 502 a knowledge corpus on a reference architecture (e.g., reference architecture 200, 402) relating to a particular solution. The solution includes, as an example, particular functionality to be performed for a particular industry, such as computing, manufacturing, transportation (e.g., airlines, trains), industrial, etc. Although particular industries are mentioned, additional, fewer and/or other industries may have a reference architecture associated therewith. Further, the knowledge corpus obtained depends on the reference architecture selected to be used.

The knowledge corpus is created, for instance, by one or more subject matter experts, and includes, for instance, an indication of various components (e.g., functions, objects, modules, templates, workflow, etc.) included in the reference architecture, and information associated with those components, such as details of the components, implementation specifics of the components, security requirements, storage requirements, etc. Although example information associated with the components of the reference architecture are mentioned, additional, fewer and/or other types of information may be included in the corpus knowledge. Further, although example components are provided, the reference architecture may include additional, fewer and/or other components. In one or more aspects, the knowledge corpus is created and/or updated automatically using, for example, artificial intelligence that analyzes and learns the information and then updates (e.g., periodically, continually as information is learned, etc.) the knowledge corpus, which is maintained in data storage, such as memory, external storage, etc.

In one example, process 500 analyzes 506 the reference architecture to obtain information regarding one or more components of the reference architecture. For instance, a reference architecture analysis engine (e.g., reference architecture analysis engine 160) analyzes one or more documents of the reference architecture to obtain the information. As an example, the analysis uses artificial intelligence, including, but not limited to, textual analysis, image analysis and natural language processing to analyze the documents. For instance, image and textual analysis of the reference architecture is performed to identify the direction of arrows, as well as starting and ending locations of the arrows; recognition of different image objects within the reference architecture; legends mentioned in the reference architecture; workflow; identification of individual function blocks; tag names of various blocks/modules; etc.

Further, process 500 integrates, in one example, with a code repository, such as, e.g., a version control tool (e.g., version control tool 300, 404) that includes, for instance, different types of code (e.g., .sql files, .config files, etc.) either in a same branch of code or different branches of code within the version control tool. Therefore, process 500 obtains 510 information identifying the version control tool.

Process 500 performs 512 code analysis using, e.g., a code analysis tool (e.g., code analysis engine 165), to analyze, for example, comments in the code included within the version control tool, use of tags within the code, use of branch names within the code, etc.; and to identify 514 various components of the code, including, for instance, one or more functional blocks, objects of the code and/or additional, fewer and/or other code components. In one example, the analysis may include analyzing requirement documents, comments on the code, review comments, test cases to learn the functionality of different code blocks, manual integration or mapping creation, etc. Additional, fewer and/or other documents and/or information may also be analyzed. In one example, the analysis uses artificial intelligence, including, but not limited to, textual analysis, image analysis, natural language processing, and/or other types of processing/analysis to parse the code and/or documents and determine identifying information of aspects of the code.

Process 500 obtains 518 the reference architecture analysis information and the code analysis information using, for instance, an integration engine (e.g., integration engine 175), which uses the information to create 520 (FIG. 5B) one or more correlations between the reference architecture and the version control tool. A correlation is a coupling between a particular portion of code in the version control tool, and more specifically, between one or more code components of the portion of code and one or more components in the reference architecture. For instance, if an identification of an object of a code branch matches an identification of a particular object in the reference architecture, then a correlation is created. This correlation may be identified by a name, a pointer, a link, an identification pair, or any other indication that can be referenced. Although example correlations are provided herein, additional, fewer and/or other correlations may be created.

Using the one or more correlations that are created and/or other information, process 500 creates 524 a mapping between the reference architecture and the version control tool. In one example, a mapping engine (e.g., mapping engine 170) is used to create a map (e.g., a data structure that includes mapping information; an image depicting the mapping information; etc.) that identifies the correlations created between the reference architecture and the version control tool. For instance, the map may include a representation of an Object A in the reference architecture and an indication of the application code for Object A in the version control tool. Many other and/or different examples are possible.

In one or more aspects, subsequent to performing the analysis and creating the correlation(s) and mapping, a user (e.g., developer or other user) may select a component in the reference architecture and automatically be guided to the corresponding portion of code (or code component) in the version control tool; and similarly, a user may select a portion of code or code component in the version control tool and automatically be guided to the corresponding component in the reference architecture. Thus, in one aspect, process 500 obtains 550 an indication of, for instance, a component (e.g., a block, functionality, group of functionalities, etc.) from the reference architecture, and based thereon, automatically (e.g., without user intervention) navigates 552, using, e.g., the mapping, to the appropriate portion of code (or code component(s)) in the version control tool. This provides the user with an automatic reference to the appropriate code for the architectural component of interest to the user.

In one embodiment, the user is able to select any granular level of functionality from the reference architecture, and thus, process 500 obtains 554 the selected granular level component(s), and automatically navigates, using, e.g., the mapping, to the appropriate portion of code (or code component(s)) in the version control tool.

Although, in the above, the user selects from the reference architecture, similarly the user may select from the version control tool and the process automatically, using, e.g., the mapping, navigates to the appropriate component(s) in the reference architecture.

In one or more aspects, an application deployed from the version control tool (or other code repository) executes, and based thereon, one or more logs (also referred to herein as status logs) are generated. The one or more logs may be of various types, including, but not limited to, an error log, a successful criteria log, usage information log, etc. In accordance with one or more aspects, information from the logs may be analyzed and selected information may be included within the reference architecture and/or the appropriate code of the version control tool. One example of this processing is described further with reference to FIG. 5B.

As one example, process 500 obtains 570 an identification of one or more application portions that generated logs. This information is obtained, for instance, from a log analysis tool (e.g., log analysis engine 180) executing on a processor set (e.g., processor set 110) that analyzes the logs. The analysis includes, for instance, analyzing text of the log, timing of code execution, etc. In one or more aspects, analysis provided by artificial intelligence techniques may be used.

Based on the log analysis, in one embodiment, process 500 indicates 572 the identified application and/or identified application log on the reference architecture. Thus, process 500 depicts 574 the log (e.g., an identifier of the log, an identifier of an application that generated the log, details of the log/application, and/or other information) on the reference architecture for view by a user, and based thereon, the mapping engine may show the portion of code (e.g., code block) associated with the log within the version control tool. This facilitates identifying which portion of the code in the version control tool is to be modified (e.g., changed, deleted, added to, etc.).

Further, in one aspect, based on the analysis of the reference architecture and the associated code in the version control tool, process 500 identifies 590, for instance, appropriate naming and tagging of a code branch or other portion of code in the version control tool, which may be deployed and executed 592.

Described above is one example of a process used to perform automatic navigation between a reference architecture and a code repository, including performing mapping and correlation between the two. One or more aspects of the process may use machine learning. For instance, machine learning may be used to identify various components of the reference architecture, identify various code components within the code repository, determine correlations between components of the reference architecture and code components of the code repository, provide information regarding generated logs, etc. A system is trained to perform analyses and learn from input data, selections made, and/or data generated.

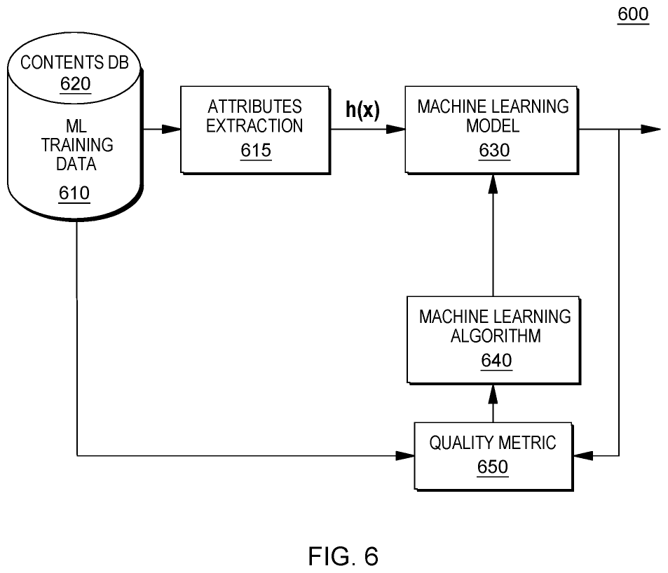

FIG. 6 is one example of a machine learning training system 600 that may be utilized, in one or more aspects, to perform cognitive analyses of various inputs, including information from a reference architecture, a knowledge corpus and/or a code repository. Training data utilized to train the model in one or more embodiments of the present invention includes, for instance, data that pertains to one or more reference architectures, data that pertains to code stored or indicated in a code repository, data within an appropriate knowledge corpus, etc. The program code in embodiments of the present invention performs cognitive analysis to generate one or more training data structures, including algorithms utilized by the program code to predict states of a given event (e.g., correlation, navigation, mapping, component identification, logging, etc.). Machine learning (ML) solves problems that are not solved with numerical means alone. In this ML-based example, program code extracts various attributes from ML training data 610 (e.g., data collected from various data sources relevant to a reference architecture component and/or code component), which may be resident in one or more databases 620 comprising component-related data and general data. Attributes 615 are utilized to develop a predictor function, h(x), also referred to as a hypothesis, which the program code utilizes as a machine learning model 630.

In identifying various event states, features and/or behaviors indicative of states in the ML training data 610, the program code can utilize various techniques to identify attributes in an embodiment of the present invention. Embodiments of the present invention utilize varying techniques to select attributes (elements, patterns, features, components, etc.), including but not limited to, diffusion mapping, principal component analysis, recursive feature elimination (a brute force approach to selecting attributes), and/or a Random Forest, to select the attributes related to various events. The program code may utilize a machine learning algorithm 640 to train the machine learning model 630 (e.g., the algorithms utilized by the program code), including providing weights for the conclusions, so that the program code can train the predictor functions that comprise the machine learning model 630. The conclusions may be evaluated by a quality metric 650. By selecting a diverse set of ML training data 610, the program code trains the machine learning model 630 to identify and weight various attributes (e.g., features, patterns, components) that correlate to various states of an event.

The model generated by the program code is self-learning as the program code updates the model based on active event feedback, as well as from the feedback received from data related to the event. For example, when the program code determines that there is information that was not previously predicted by the model (e.g., a correlation between the architecture reference and the code repository), the program code utilizes a learning agent to update the model to reflect the state of the event, in order to improve predictions in the future. Additionally, when the program code determines that a prediction is incorrect, either based on receiving user feedback through an interface or based on monitoring related to the event, the program code updates the model to reflect the inaccuracy of the prediction for the given period of time. Program code comprising a learning agent cognitively analyzes the data deviating from the modeled expectations and adjusts the model to increase the accuracy of the model, moving forward.

In one or more embodiments, program code, executing on a processor set, utilizes an existing cognitive analysis tool or agent (or one to be developed) to tune the model, based on data obtained from one or more data sources. One or more embodiments utilize, for instance, an IBM Watson® system as the cognitive agent. In one or more embodiments, the program code interfaces with IBM Watson Application Programming Interfaces (APIs) to perform a cognitive analysis of obtained data (e.g., reference architecture data, code repository data, knowledge corpus data, etc.). Specifically, in one or more embodiments, certain of the APIs of the IBM Watson API comprise a cognitive agent (e.g., learning agent) that includes one or more programs, including, but not limited to, natural language classifiers, Retrieve and Rank (i.e., a service available through the IBM Watson Developer Cloud™ that can surface the most relevant information from a collection of documents), concepts/visual insights, trade off analytics, document conversion, and/or relationship extraction. In an embodiment, one or more programs analyze the data obtained by the program code across various sources utilizing one or more of a natural language classifier, retrieve and rank APIs, and trade off analytics APIs. The IBM Watson Application Program Interface (API) can also provide audio related API services, in the event that the collected data includes audio, which can be utilized by the program code, including but not limited to natural language processing, text to speech capabilities, and/or translation. IBM Watson® and IBM Watson Developer Cloud™ are registered trademarks or trademarks of International Business Machines Corporation in at least one jurisdiction.

In one or more embodiments, the program code utilizes a neural network to analyze event-related data to generate the model utilized to predict the state of a given event at a given time. Neural networks are a biologically-inspired programming paradigm which enable a computer to learn and solve artificial intelligence problems. This learning is referred to as deep learning, which is a subset of machine learning, an aspect of artificial intelligence, and includes a set of techniques for learning in neural networks. Neural networks, including modular neural networks, are capable of pattern recognition with speed, accuracy, and efficiency, in situations where data sets are multiple and expansive, including across a distributed network, including but not limited to, cloud computing systems. Modern neural networks are non-linear statistical data modeling tools. They are usually used to model complex relationships between inputs and outputs or to identify patterns in data (i.e., neural networks are non-linear statistical data modeling or decision making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in multiple source processing, which the program code in one or more embodiments accomplishes when obtaining data and generating a model for predicting states of a given event.

One or more aspects, including, but not limited to, analysis, mapping and navigational aspects, may utilize artificial intelligence, and in particular, machine learning in the decision-making process. A model is trained to be able to perform certain tasks, such as, but not limited to, identify the components of a reference architecture and corresponding code components of a code repository, and identify correlations between the components of the reference architecture and the code repository. This model is then used in one or more aspects. For instance, it is used to perform mapping and automatic navigation between the reference architecture and code repository. Other aspects may also be performed by artificial intelligence (e.g., machine learning) including, e.g., updating the reference architecture and/or code repository based on log data, etc.

As described herein, in one or more aspects, a knowledge corpus of reference architectures of various implementations and functionalities for various industries is obtained, created and/or automatically updated based on processing of one or more aspects of the present invention. In one or more aspects, a knowledge corpus is created that considers various functional areas (e.g., technological functional areas, business functional areas, additional and/or other functional areas), technical implementations, etc.

In one or more aspects, a reference architecture has different types of documents, including different types of diagrams; has names of technologies; and/or includes implementation steps, workflow, textual information, best practices, etc. It may include additional, fewer and/or other information in various examples.

In one or more aspects, an image analysis and natural language processing module (e.g., included in and/or used by reference architecture analysis engine 160) is provided, which analyzes the reference architecture. The reference architecture is analyzed and individual functional blocks and associated tag names, functionality names, etc. are identified.

In one or more aspects, there is an integration with a version control tool (or other code repository), and the version control tool includes different types of code either in a same branch of code or different branches of code. A code analysis tool (e.g., code analysis engine 165) analyzes the code in the version control tool, including, for instance, comments in the code, tagging within the code, branch names used within the code, etc. Various functional blocks, objects from the code and/or other code components are identified, in one or more aspects.

In one or more aspects, an artificial intelligence module is used, e.g., for analysis (e.g., by reference architecture analysis engine 160, code analysis engine 165, mapping engine 170, integration engine 175 and/or log analysis engine 180) and has and/or identifies different applications, application functionality metadata, information related to different types of objects, etc.

In one or more aspects, an integration module (e.g., integration engine 175) receives reference architecture analysis information and code analysis information and creates one or more correlations between the reference architecture and the version control tool (or other code repository). References of different code within the reference architecture are created and a mapping is provided to the appropriate code branches in the version control tool, in one or more aspects.

In one or more aspects, a user (e.g., developer or other user) may select any block or functionality or a group of functionalities from the reference architecture. An identification of the mapping within the code block is provided, as well as a navigation to the appropriate portion of code within the version control tool (or other code repository). The user, in one or more aspects, may select from the reference architecture, any granular level of functionality, and accordingly, the process automatically navigates the user to the appropriate code portion in the code repository.

In one or more aspects, generated logs are used by, e.g., a log analysis tool (e.g., log analysis engine 180) to identify, at least, which portion of the application has generated a log, such as an error log, successful criteria log, usage information log, etc. The portion of the code that generated the log is identified from, e.g., the analysis. The log is depicted, in one or more aspects, on the reference architecture. A developer or other user can view the log on the reference architecture and from there, the mapping module (e.g., mapping engine 170) shows the corresponding code block from the version control tool. Other examples and features of using logs are also possible.

In one or more aspects, based on the reference architecture and code analyses, appropriate naming and tagging of code branch(es) are identified and the same may be executed in the code block(s).

In one or more aspects, a code branch of a code repository is dynamically aligned with a reference architecture, and a user may perform interaction with the reference architecture to select a corresponding code branch (or perform interaction with the code repository to select one or more corresponding components of the reference architecture).

In one or more aspects, the tags of code in a version control tool (or other code repository) are analyzed, as well as code functionalities. Image analysis and textual analysis of the reference architecture are performed, and accordingly, the code is aligned as per the reference architecture and a proper mapping is created.

In one or more aspects, in the reference architecture, the user may select any selected block mapped with any functionality, and accordingly, the user can directly be navigated to the appropriate portion of the code (e.g., code branch) in the code repository.

In one or more aspects, various logs (e.g., success criteria, failure criteria, usage parameters (e.g., concurrent users), etc.) generated by the application are analyzed, and accordingly, the same will be shown on the reference architecture, such that a user (e.g., developer, architect, etc.) may identify the changes to be applied to the code.

In one or more aspects, a user may navigate to granular level functionalities in the reference architecture, and accordingly, the appropriate code block or functionality in any code, etc. is shown such that navigation on the code repository is performed with the reference architecture.

In one or more aspects, if any new branch (or other code) is created in the version control tool, then the reference architecture is dynamically synchronized with the version control tool and a notification is provided if any correction is to be performed in the code branch (or other code). For instance, the reference architecture is automatically modified to include, e.g., an indication of the new branch and how it is related to one or more components of the reference architecture. The code branch naming and tagging are dynamically selected based on the reference architecture.

One or more aspects of the present invention are tied to computer technology and facilitate processing within a computer, improving performance thereof. By having a process that provides a correlation and mapping between a reference architecture and a code repository, processing time and/or resource usage in developing code, using code and/or executing code is reduced, improving performance. Efficiencies in processing are provided, saving system resources and improving performance. This improves processing within a processor, computer system and/or computing environment.

In one or more aspects, navigation to a code branch within a code repository is facilitated, thereby facilitating deployment and execution of selected code branches. In one example, code within a code repository is branched based on, e.g., functionalities. Thus, deploying code for selected functionality or modifying/enhancing the code, navigation to a particular code branch is to be performed. This navigation is facilitated in one or more aspects.

Although various aspects, variations and embodiments are described herein, other aspects, variations and/or embodiments are possible without departing from a spirit of aspects of the present invention.

The computing environment(s) described herein are only examples of computing environments that can be used. Other environments, including but not limited to, non-partitioned environments, partitioned environments, cloud environments, quantum environments distributed environments, non-distributed environments, virtual environments and/or emulated environments, may be used; embodiments are not limited to any one environment. Although various examples of computing environments are described herein, one or more aspects of the present invention may be used with many types of environments. The computing environments provided herein are only examples.

Each computing environment is capable of being configured to include one or more aspects of the present invention. For instance, each may be configured to provide an automatic navigation process between a reference architecture and a code repository, perform mapping and/or correlations, perform analysis and/or to perform to one or more other aspects of the present invention.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating processing within a computing environment, the computer-implemented method comprising:
obtaining information based on an action performed relating to a portion of code of an application stored using a code repository, the portion of code dynamically aligned with at least one component of a reference architecture relating to the application, wherein a correlation exists between the portion of code of the code repository and the reference architecture; and
automatically navigating to a specified location based on the information, the specified location being one of a selected area in the code repository and a selected area in the reference architecture.

2. The computer-implemented method of claim 1, wherein the information comprises an indication that the portion of code generated a status log based on execution of the application, and wherein the specified location is the selected area in the reference architecture.

3. The computer-implemented method of claim 1, wherein the information comprises an indication of a user selected component of the reference architecture, and wherein the specified location is the selected area in the code repository.

4. The computer-implemented method of claim 3, wherein the user selected component is at a selected granular level of functionality of a plurality of granular levels of functionality within the reference architecture.

5. The computer-implemented method of claim 1, wherein the information comprises an indication of a user selected code portion of the code repository, and wherein the specified location is the selected area in the reference architecture.

6. The computer-implemented method of claim 1, further comprising dynamically aligning the portion of code with the at least one component of the reference architecture relating to the application, wherein the dynamically aligning provides the correlation between the portion of code of the code repository and the reference architecture.

7. The computer-implemented method of claim 6, wherein the dynamically aligning comprises:
analyzing one or more code components of the portion of code to provide code analysis;
analyzing one or more components of the reference architecture to provide reference architecture analysis;
using the code analysis and the reference architecture analysis to correlate the portion of code with the at least one component of the reference architecture.

8. The computer-implemented method of claim 7, wherein the analyzing the one or more code components comprises analyzing one or more tags and functionality of, at least, the one or more code components.

9. The computer-implemented method of claim 7, wherein the analyzing the one or more components of the reference architecture includes performing image analysis and textual analysis of, at least, the one or more components of the reference architecture.

10. The computer-implemented method of claim 1, further comprising:
obtaining an indication that new code has been added to the code repository; and
automatically synchronizing the reference architecture to include one or more components representing the new code.

11. A computer system for facilitating processing within a computing environment, the computer system comprising:
a memory; and
one or more processors in communication with the memory, wherein the computer system is configured to perform a method, said method comprising:
obtaining information based on an action performed relating to a portion of code of an application stored using a code repository, the portion of code dynamically aligned with at least one component of a reference architecture relating to the application, wherein a correlation exists between the portion of code of the code repository and the reference architecture; and
automatically navigating to a specified location based on the information, the specified location being one of a selected area in the code repository and a selected area in the reference architecture.

12. The computer system of claim 11, wherein the information comprises an indication that the portion of code generated a status log based on execution of the application, and wherein the specified location is the selected area in the reference architecture.

13. The computer system of claim 11, wherein the information comprises an indication of a user selected component of the reference architecture, and wherein the specified location is the selected area in the code repository.

14. The computer system of claim 11, wherein the information comprises an indication of a user selected code portion of the code repository, and wherein the specified location is the selected area in the reference architecture.

15. The computer system of claim 11, further comprising dynamically aligning the portion of code with the at least one component of the reference architecture relating to the application, wherein the dynamically aligning provides the correlation between the portion of code of the code repository and the reference architecture.

16. A computer program product for facilitating processing within a computing environment, said computer program product comprising:
one or more computer readable storage media and program instructions collectively stored on the one or more computer readable storage media readable by at least one processing circuit to perform a method comprising:
obtaining information based on an action performed relating to a portion of code of an application stored using a code repository, the portion of code dynamically aligned with at least one component of a reference architecture relating to the application, wherein a correlation exists between the portion of code of the code repository and the reference architecture; and
automatically navigating to a specified location based on the information, the specified location being one of a selected area in the code repository and a selected area in the reference architecture.

17. The computer program product of claim 16, wherein the information comprises an indication that the portion of code generated a status log based on execution of the application, and wherein the specified location is the selected area in the reference architecture.

18. The computer program product of claim 16, wherein the information comprises an indication of a user selected component of the reference architecture, and wherein the specified location is the selected area in the code repository.

19. The computer program product of claim 16, wherein the information comprises an indication of a user selected code portion of the code repository, and wherein the specified location is the selected area in the reference architecture.

20. The computer program product of claim 16, wherein the method further comprises dynamically aligning the portion of code with the at least one component of the reference architecture relating to the application, wherein the dynamically aligning provides the correlation between the portion of code of the code repository and the reference architecture.
